(19) United States
(12) Patent Application Publication
(10) Pub. No.: US 2003/0231850 A1
(43) Pub. Date: Dec. 18, 2003

(54) Optical fiber array

(76) Inventors: John F. Filhaber, Corning, NY (US); David S. Franzen, Painted Post, NY (US); John S. Peanasky, Foothill Ranch, CA (US); Robert Sabia, Corning, NY (US); Jackson P. Trentelman, Lawrenceville, PA (US)

Correspondence Address: CORNING INCORPORATED, SP-TI-3-1, CORNING, NY, 14831

(21) Appl. No.: 10/386,982

(22) Filed: Mar. 12, 2003

Related U.S. Application Data
(60) Provisional application No. 60/365,680, filed on Mar. 18, 2002.

(51) Int. Cl. G02B 6/00

(52) U.S. Cl. 385/137

(57) ABSTRACT

A fiber array includes a substrate made of a soft drillable material and a plurality of holes drilled through the substrate for holding a plurality of glass fibers.

### CROSS REFERENCE TO RELATED APPLICATIONS

This application claims priority from U.S. Provisional Application No. 60/365,680, filed Mar. 18, 2002.

### BACKGROUND OF INVENTION

1. Field of the Invention

The invention relates generally to fiber-optic network systems. More specifically, the invention relates to a method and device for aligning glass fibers, such as optical fibers, lensed fibers, and rod lenses.

2. Background Art

Fiber-optic light-wave technology has found enormous application in long-distance communication. Copper wires and coaxial cables, and even microwave relays and satellites in some cases, are being replaced by fiber-optic systems. Fiber-optic links have several advantages over their metallic-based counterparts. These advantages include lower loss, higher information-carrying capacity, lower cost per channel, and a smaller physical mass. Currently, fiber-optic links carry hundreds of terabits per second over distances greater than 1,000 km. Even though this is orders of magnitude beyond the capacity of metallic links, the demands of global communication are driving the system capacity to double every year. To meet these demands, techniques such as wavelength division multiplexing (WDM) are being used to increase the transmission capacity of the fiber-optic link.

In WDM systems, many optical signals at different wavelengths are combined into a single beam for transmission in a single optical fiber. At the exit of the fiber, a demultiplexer is used to separate the beam by wavelength into independent signals. In communication networks employing transmission formats such as WDM, a cross-connect is needed to selectively route individual optical signals to different destinations. An N×N cross-connect is a switch fabric that can switch a signal from any of N transmission lines to another of the N transmission lines. In optical networks, the majority of the signal routing is still performed electronically. This requires frequent optical-to-electrical and electrical-to-optical signal conversion, which slows down the network. To take full advantage of speed and bandwidth of optical signal transmission, an all optical network is required.

One approach to large-scale optical cross-connect is based on free-space (three-dimensional) micro-optic switching. In micro-optic switching, the optical signal from a channel is re-routed by an array of micro-electronic (MEMS) actuated mirrors or prisms to any of the other output channels and then focused back into the output fiber by an array of collimating lenses. For free-space micro-optic switching (as well as two-dimensional switching), the optical fibers need to be arrayed and aligned with the array of collimating lenses. The challenge in making these large-scale optical switches is how to efficiently align a large number of optical fibers to a large lens array. The current method for aligning fibers to a lens array involves gluing or splicing optical fibers to a substrate with an array of collimating lens. Each fiber-lens alignment can take 6 to 12 minutes, which makes the method unsuitable for large-scale optical switch having several hundred ports. In addition, there is adhesive in the optical path when the fiber is secured to the lens array by gluing, and the athermalization performance of this fiber-lens connection is unknown.

Instead of serially aligning fibers to a lens array, a fiber array can be constructed and mated to a lens array. The fiber array can be populated more quickly with fibers. The general approach is to make the fiber array with V-grooves etched in silicon and stacked in piles. In this approach, any associated lens array would need to match silicon in expansion to achieve athermalization. There is a certain cost and accuracy limit associated with this approach. Furthermore, there are limits for silicon V-groove technology in terms of two-dimensional pitch tolerances that essentially eliminates its application to M×N arrays (where M and N>>1). To improve fiber-lens alignment accuracy, the fiber array can be populated with lensed fibers. A lensed fiber is a monolithic device having an optical fiber terminated with a lens. Lensed fibers allow for improved alignment accuracy because the signal is collimated before exiting the lensed fiber, thus requiring less active fiber-lens alignment. Lastly, lensed fibers also have low insertion loss.

### SUMMARY OF INVENTION

In one aspect, the invention relates to a fiber array which comprises a substrate made of a soft drillable material and a plurality of holes drilled through the substrate for holding a plurality of glass fibers.

In another aspect, the invention relates to an optical device which comprises a fiber array mated to a lens array, wherein the fiber array comprises a substrate made of a soft drillable material having a low coefficient of thermal expansion and a plurality of holes drilled through the substrate for holding a plurality of glass fibers, and a lens array comprising a material exhibiting a coefficient of thermal expansion that substantially matches the coefficient of thermal expansion of the soft drillable material.

In yet another aspect, the invention relates to a method of making a fiber array which comprises drilling a plurality of holes through a substrate made of a soft drillable material having a low coefficient of thermal expansion, inserting glass fibers into the holes, and securing the glass fibers in place in the holes.

In another aspect, the invention relates to a method of making a fiber array which comprises drilling a plurality of holes through a substrate made of a soft drillable material having a low coefficient of thermal expansion, inserting glass fibers into the holes, securing the glass fibers in place in the holes, and forming a lens on an end of the each of the glass fibers protruding from a face of the substrate.

Other features and advantages of the invention will be apparent from the following description and the appended claims.

### BRIEF DESCRIPTION OF DRAWINGS

FIG. 1A shows a fiber array according to an embodiment of the invention.

FIG. 1B is a vertical cross-section of the fiber array in FIG. 1A.

FIGS. 2A-2F illustrate a process for populating a fiber array with optical fibers according to one embodiment of the invention.

FIG. 3 shows a fiber array mated with a lens array according to one embodiment of the invention.

FIG. 4A is a schematic of a lensed fiber.

FIG. 4B shows a lensed fiber inserted in a fiber array according to another embodiment of the invention.

FIGS. 5A-5D illustrate a process for populating a fiber array with lensed fibers according to another embodiment of the invention.

### DETAILED DESCRIPTION OF THE PREFERRED EMBODIMENTS

The invention will now be described in detail with reference to a few preferred embodiments, as illustrated in accompanying drawings. In the following description, numerous specific details are set forth in order to provide a thorough understanding of the invention. It will be apparent, however, to one skilled in the art, that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

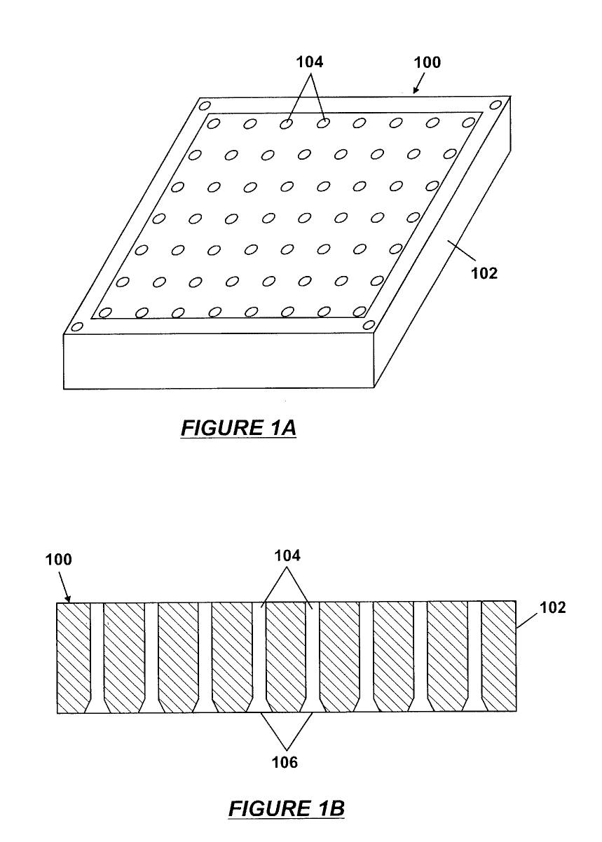

A fiber array consistent with the principles of the invention is inexpensive to manufacture, athermal, and highly accurate in core-to-core positioning and axial alignment of glass fibers, such as optical fibers, lensed fibers, and rod lenses. For illustration purposes, FIG. 1A shows a fiber array 100 according to an embodiment of the invention. The fiber array 100 includes a substrate 102 having a plurality of holes 104 in a predetermined pattern. The holes 104 are receptacles for glass fibers (not shown). The profile of the holes 104 may be tailored to match the profile of the glass fibers and/or to facilitate insertion of the glass fibers into the holes 104, as will be further described below. The holes 104 are drilled through the substrate 102 using conventional machining techniques, preferably computer-numerical-controlled (CNC) machining techniques, which will allow better control of positioning and dimensions of the holes 104 in the substrate 102.

The choice of material for the substrate 102 is important because very small diameter holes with significant depth (relative to the diameter) would have to be drilled through the substrate 102, usually with very small hole-to-hole spacing. Therefore, the substrate material should be selected such that hole-dimensional integrity is maintained throughout the fiber array 100. The thermal expansion of the substrate material may also have to be matched to fused silica, or other similar glass material, to achieve athermalization. In one embodiment, the substrate 102 is made of a soft drillable material, i.e., a material that can easily be drilled using conventional machining techniques. Examples of soft drillable materials include, but are not limited to, pyrolytic graphite, other machinable graphite grades, and machinable ceramics, such as pyrolytic boron nitride and other machinable boron nitride grades. In one embodiment, the soft drillable material has a coefficient of thermal expansion (CTE) that is similar to or matches that of a lens array to be mated to the fiber array 100. In one embodiment, the soft drillable material has a low CTE, e.g., ranging from about 0.5×10⁻⁶ to 8.0×10⁻⁶/° C.

Pyrolytic graphite is advantageous to the demands of a fiber array in at least two respects. First, pyrolytic graphite is a highly anisotropic material in terms of its thermal properties. Along the basal plane, also known as the “ab” plane, pyrolytic graphite has a very low CTE of about 0.5×10⁻⁶/° C. at room temperature and about 0.68×10⁻⁶/° C. at 2000° C. This makes pyrolytic graphite inherently athermal and an excellent expansion match to fused silica, should it be important to match the fiber array to a lens array made of fused silica. Perpendicular to the basal plane, also known as the “c” plane, pyrolytic graphite has a CTE of about 6.8×10⁻⁶/° C. at room temperature and about 8.0×10⁻⁶/° C. at 2000° C. This also makes pyrolytic graphite an excellent expansion match to a lens array made from photonucleable (or photosensitive) glass, such as Coming SMILE® lens array, or other glass having a higher CTE than fused silica.

Secondly, pyrolytic graphite is relatively soft, making it possible to drill very small diameter holes, e.g., 126-μm holes, to significant depths relative to diameter. Holes have been drilled in pyrolytic graphite using carbide twist drills, although other types of drills can also be used. It has been demonstrated that holes at least ten times deeper than hole diameter can be drilled through the material while maintaining hole dimensional integrity throughout the fiber array. This would not be possible using any low-expansion metal such as invaru. It has also been demonstrated that hole location can be controlled to within a few microns, e.g., within 2 μm of a target position. Because the holes in the fiber array substrate have significant depth relative to diameter, and because the diameters of the holes can be held within a few microns, additional error (e.g., in optical switching performance) due to fiber insertion location and pointing error are minimized. Further, because of the soft nature of pyrolytic graphite, additional detail can be machined into the hole geometry as necessary to allow glass fibers to be easily threaded into the holes.

FIG. 1B shows a vertical cross-section of the fiber array 100. To facilitate insertion of glass fibers (not shown) into the holes 104, the holes 104 may be terminated with tapered or flared holes 106. Alternatively, other enlarged hole geometry, such as a counterbore, may be used in place of the tapered holes 106. An added advantage of the tapered holes 106 is that adhesive can amass around the portion of the glass fibers in the tapered holes 106, thereby allowing a robust connection to be formed between the fiber array 100 and the glass fibers. This makes it easier to handle the assembled fiber array.

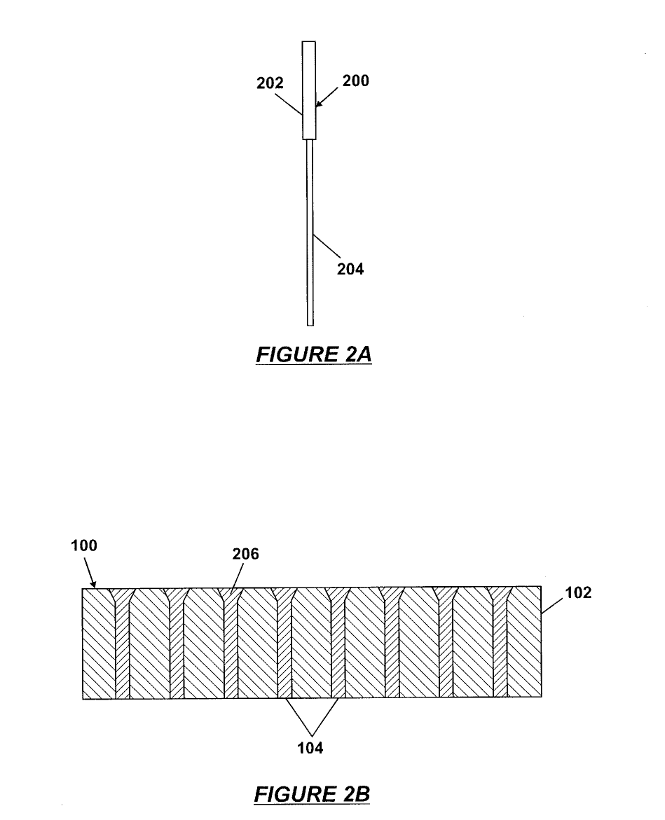

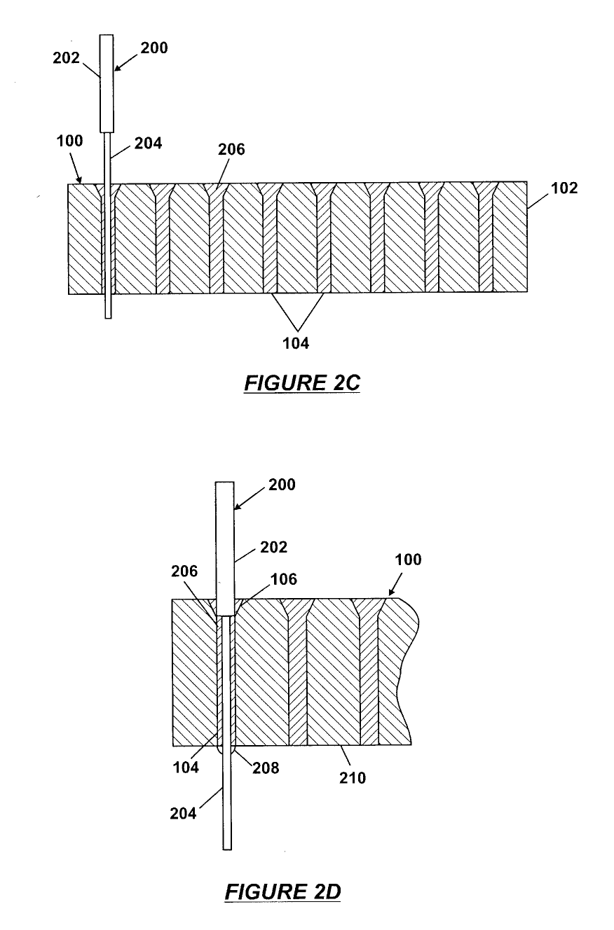

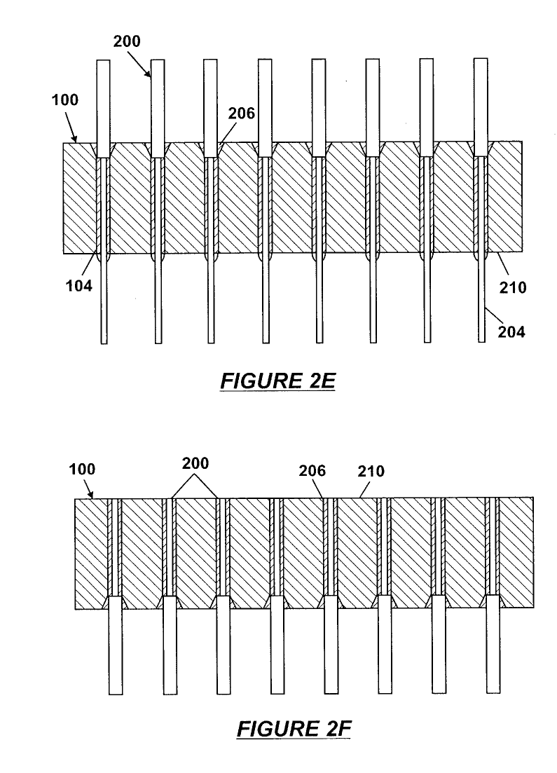

Populating the fiber array 100 with glass fibers is straightforward. One example of a process of populating the fiber array 100 is illustrated in FIGS. 2A-2F. The process starts by stripping and cleaning optical fiber ends. FIG. 2A shows an optical fiber 200 having a buffered fiber 202 and a stripped fiber 204. As shown in FIG. 2B, the process next involves filling the holes 104 in the fiber array 100 with epoxy 206 or other suitable thermoset or adhesive material. The holes 104 may be filled with epoxy 206 using a dispensing needle. Next, as shown in FIG. 2C, the optical fiber 200 is inserted into the hole 104. As shown in FIG. 2D, the optical fiber 200 is threaded through the hole 104 until the buffered fiber 202 fills the tapered hole 106. Then, the stripped fiber 204 protruding beyond the face 210 of the fiber array 100 is tacked in place, as shown at 208, with a UV-curable epoxy or other thermoset material to prevent the optical fiber 200 from being pulled out of the hole 104 while the remaining holes 104 in the fiber array 100 are populated with optical fibers.

FIG. 2E shows the fiber array 100 after it has been completely populated with optical fibers 200. After populating the fiber array 100, the fiber array 100 is heated to thermally cure the epoxy 206, thus forming a robust connection between the optical fibers 200 and the fiber array 100. The next step is to remove the excess stripped fiber 204 protruding beyond the face 210 of the fiber array 100. One method for removing the excess fiber is by manually snipping the fiber ends off with a wire cutter. Another method for removing the excess fiber is by cutting the fiber ends with a wiresaw. In both of these methods, there is the risk of breaking the fibers. In both of these methods, the entire face 210 of the fiber array 100 would need to be re-potted with epoxy (or other polymer) to cover the exposed ends of the fibers 200. The ends of the fibers 200 (encapsulated in epoxy) are then lapped and polished to desired flatness, and the face 210 of the fiber array 100 is polished and surface-finished. The amount of polishing required to achieve the desired flatness can be substantial. To reduce the amount of polishing, the excess fiber can be removed by applying a single pulse of a laser near the face 210 of the fiber array 100 to vaporize the fiber ends. The face 210 can then be polished and surface-finished. FIG. 2F shows the final product.

It should be noted that pyrolytic graphite can be flammable. Therefore, when the fiber array 100 is made of pyrolytic graphite or other flammable material, care should be taken to ensure that the fiber array 100 is not damaged while cutting the fiber ends with laser. Various types of lasers can be used in the invention, e.g., CO₂, Nd-YAG, etc. In an experiment with 10-W CO₂ laser, a sample of pyrolytic graphite was irradiated for approximately 30 seconds with no visible damage to the pyrolytic graphite. The sample became heated, however. This is because of the anisotropic thermal conductivity characteristics of the pyrolytic graphite. This means that the laser can be used to cure the epoxy 206 used to secure the fibers 200 to the fiber array 100 while cutting the fiber ends. In other words, a separate heating step to cure the epoxy 206 may not be needed. It should be noted that a ball (not shown) may form at the end of the fiber 200 if the fiber end does not vaporize quickly. Typically, the size of the ball decreases as the laser power increases. The ball may serve to further lock the fiber 200 in place during the polishing step. The ball may also serve to increase the mode field diameter at the end of the fiber 200, which could reduce insertion losses when coupling light into the fiber 200.

The fiber array of the invention is suitable for use in aligning an array of optical fibers with a lens array. The lens array may be one made by molding or by thermal opacification of a photonucleable glass or by other suitable method. Photonucleable glasses are described in, for example, U.S. Pat. Nos. 2,326,012, 2,422,472, 2,515,936, 2,515,938, 2,515,275, 2,515,942 and 2,515,943, the contents of which are incorporated herein by reference. Methods for transforming a photonucleable glass to a lens array are described in, for example, U.S. Pat. Nos. 4,572,611, 4,518,222 and 5,062,877, the contents of which are incorporated herein by reference. One commercial implementation of a method for transforming a photonucleable glass to a lens array is known as SMILE® process. In general, a photonucleable glass is transformed into a lens array by subjecting it to an ultraviolet radiation step, a heat treatment step, and an ion exchange step. When the photonucleable glass is subjected to ultraviolet radiation, the exposed portions undergo shrinkage, exerting a compressive force on the unexposed portions and drawing them into a raised pattern with a smooth curved surface, which can act as a lens.

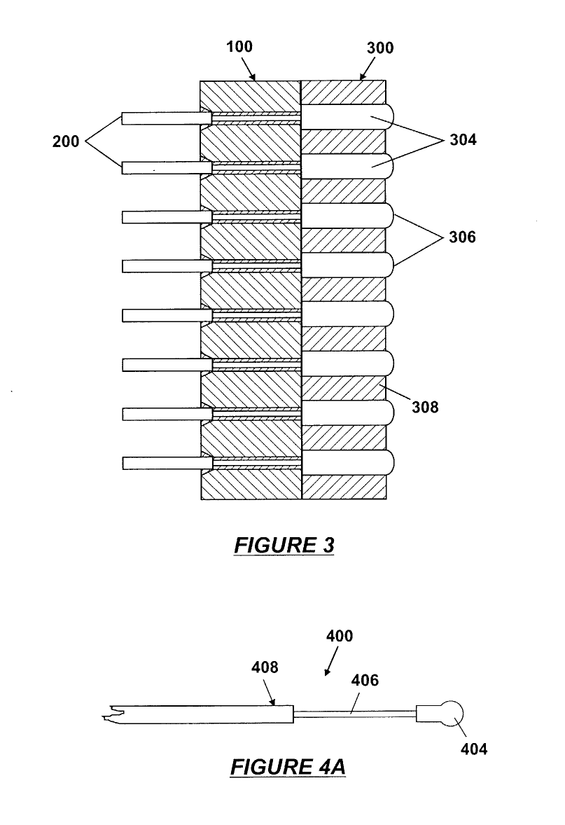

FIG. 3 shows the fiber array 100 aligned with a lens array 300. In a specific example, the lens array 300 is formed from a photonucleable glass, such as FOTOFORM® glass, and includes light-transmitting channels 304 and spherical lenses 306, where the spherical lenses are connected to the light-transmitting channels 304. The channels 304 and the spherical lenses 306 are the uncrystallized portion of the photonucleable glass. The channels 304 are surrounded by crystallized (or glass-ceramic) matrix 308. In this example, the fiber array 100 provides individual alignment of optical fibers 200 with corresponding light-transmitting channels 304 and spherical lenses 306 in the lens array 300. The fiber array 100 eliminates the need to serially align each of the optical fibers 200 with the corresponding light-transmitting channel 304 and spherical lens 306. Further, the fiber array 100 provides highly accurate core-to-core positioning and axial alignment of the optical fibers 200.

The invention has been described so far with respect to inserting optical fibers into the drilled holes in a fiber array. However, as previously mentioned, the fiber array of the present invention can also be populated with lensed fibers. In one embodiment of the invention, the geometry of the holes (104 in FIG. 1A) in the fiber array (100 in FIG. 1A) is modified to accommodate lensed fibers. In the following sections, a lensed fiber will be described first. Then, a fiber array having a modified hole geometry to accommodate the lensed fiber will be described.

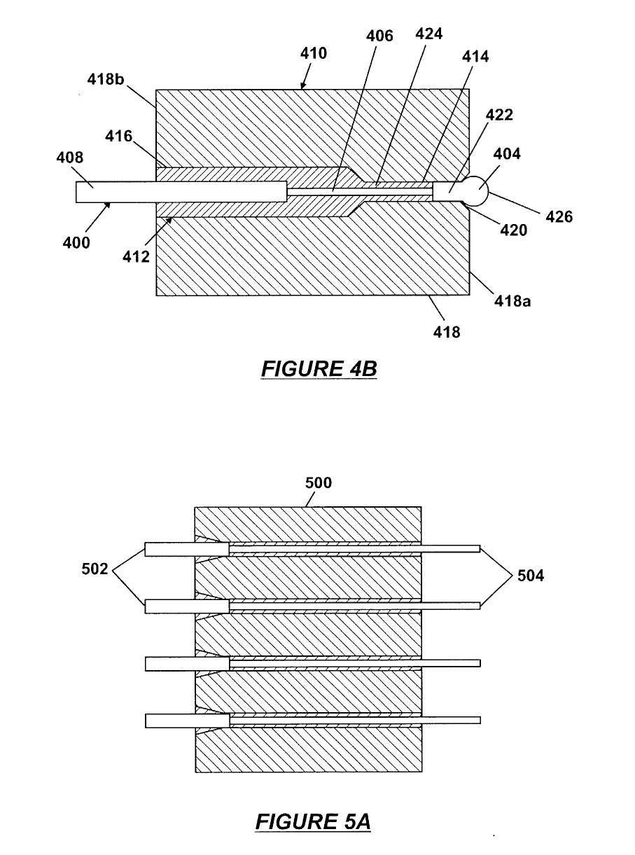

FIG. 4A shows a lensed fiber 400 having a planoconvex lens 404 attached to, or formed at, an end of an optical fiber 406. The optical fiber 406 is a stripped region of a fiber pigtail 408. FIG. 4B shows a partial cross-section of a fiber array 410 having a drilled hole 412 for receiving the lensed fiber 400. Typically, the fiber array 410 would include multiple drilled holes, such as drilled hole 412, arranged in a predetermined pattern. The fiber array 410 may be constructed of pyrolytic graphite or other grades of graphite or other soft drillable materials, as previously discussed. The geometry of the drilled hole 412 includes a small-diameter hole 414 and a large-diameter hole 416. The small-diameter hole 414 is drilled from the front surface 418a of the fiber array substrate 418, while the large-diameter hole 416 is drilled from the back surface 418b of the substrate 418. A chamfer (or tapered hole or counterbore) 420 is formed at the end of the small-diameter hole 414.

The diameter of the small-diameter hole 414 is slightly larger than the diameter of the fiber pigtail 408. This allows the entire length of the fiber pigtail 408 to be inserted into the large-diameter hole 416 through the chamfer 420 and small-diameter hole 414. The chamfer 420 provides a holding place for the lens 404 and adds precision to lens height control. The neck region 422 behind the lens 404 has a diameter that matches the diameter of the small-diameter hole 414. This allows the neck region 422 to fit snugly in the chamfer 420. The neck region 422 is further secured in place using an optical adhesive, such as epoxy. Adhesive 424 is also used to seal the optical fiber 406 in the small-diameter hole 414. The chamfer 420 aids in accurately positioning the front surface 426 of the lens 404 with respect to the front surface 418a of the substrate 418. If desired, the chamfer 420 can be widened to allow the front surface 426 of the lens 404 to be flush with the front surface 418a of the substrate 418.

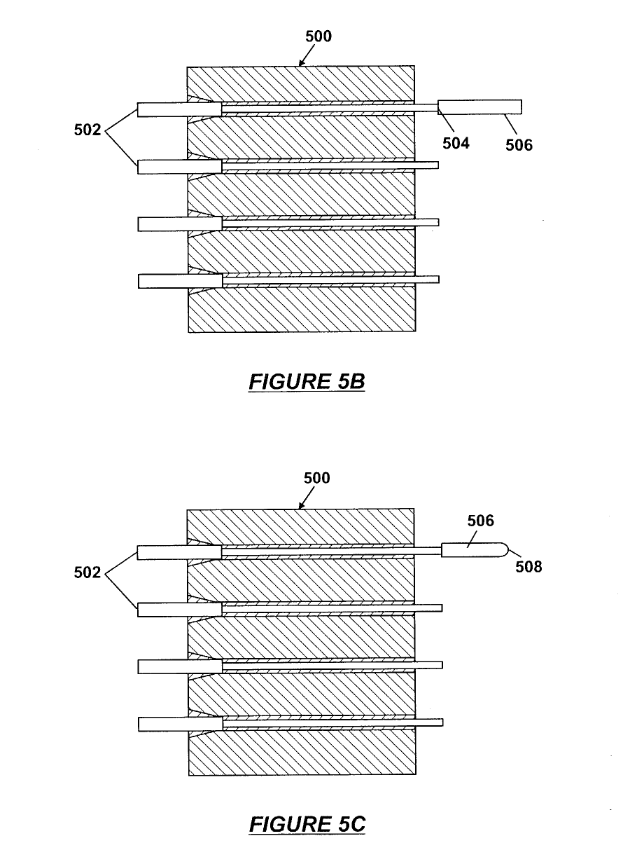

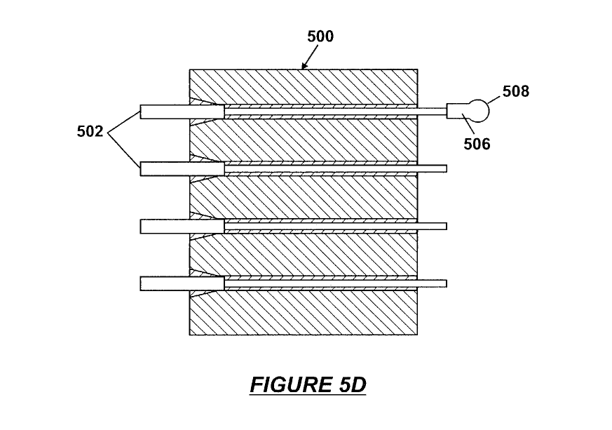

Another method for populating a fiber array with lensed fibers includes first populating the fiber array with optical fibers as previously described in FIGS. 2A-2E, and then attaching or forming planoconvex lenses at the ends of the optical fibers. FIG. 5A shows a fiber array 500 populated with optical fibers 502. The fiber ends 504 protruding from the front surface 506 of the fiber array 500 have been reduced to a desired thickness and flatness, e.g., by lapping and polishing or by use of a laser. At this point, planoconvex lenses can be attached to or formed at the fiber ends 504. A method of forming planoconvex lenses at the fiber ends 504 includes splicing a length of glass fiber to each of the fiber ends 504 using, for example, a filament or laser. FIG. 5B shows a glass fiber 506 spliced to the fiber ends 504. The next step is to taper-cut the glass fiber 506 to the desired length. This process involves moving a heat source, such as a filament, along the glass fiber 506 while applying axial tension to the glass fiber 506. FIG. 5C shows the glass fiber 506 after taper-cutting. The tip 508 of the glass fiber 506 has a small radius of curvature, typically in a range from 5 to 20 μm. This radius of curvature can be enlarged by an additional step, called a melt-back step. The melt-back step involves moving a heat source towards the tip 508, allowing surface tension to pull the tip 508 into a large sphere. FIG. 5D shows the glass fiber 506 after a melt-back step.

The invention provides one or more advantages. The invention provides a method for constructing a fiber array that is highly accurate and stable in dimensions, i.e., overall surface flatness, hole diameter, and hole-to-hole spacing. The fiber array can be constructed using known technology, e.g., CNC machining, and known and readily-available machinable materials. The fiber array can be deployed with a lens array produced by a variety of methods without the use of optical adhesive in the optical path. The material used in making the fiber array can be expansion-matched to the material used in making the lens array to achieve athermalization. Constructing the fiber array from pyrolytic graphite is advantageous when the lens array is made of fused silica or from a photonucleable glass such as FOTOFORM®. The fiber array can be populated with optical fibers or lensed fibers or rod lenses. Fiber arrays populated with lensed fibers allow for improved alignment accuracy because the signal is collimated before exiting the lensed fiber. For a design that includes lensed fibers, a centering accuracy of ±3 μm is required as compared to the ±1 μm accuracy required for alignment of standard fibers. The fiber array can also be deployed with other optical devices, such as a single large collimating lens.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fiber array, comprising:
a substrate made of a soft drillable material; and
a plurality of holes drilled through the substrate for holding a plurality of glass fibers.

2. The fiber array of claim 1, wherein the soft drillable material exhibits a low coefficient of thermal expansion.

3. The fiber array of claim 2, wherein the soft drillable material comprises one selected from the group consisting of machinable graphite and machinable ceramic.

4. The fiber array of claim 2, wherein the soft drillable material comprises one selected from the group consisting of pyrolytic graphite, graphite, pyrolytic boron nitride, and boron nitride.

5. The fiber array of claim 1, wherein the soft drillable material exhibits a coefficient of thermal expansion less than about 1.0×10⁻⁶/° C.

6. The fiber array of claim 1, wherein the soft drillable material exhibits a coefficient of thermal expansion ranging from about 0.5×10⁻⁶ to 8.0×10⁻⁶/° C.

7. The fiber array of claim 1, wherein the glass fibers are terminated with planoconvex lenses.

8. The fiber array of claim 7, wherein a geometry of the holes comprises a first hole section having a diameter substantially the same as a neck region of the lenses.

9. The fiber array of claim 8, wherein the geometry of the holes further comprises a second hole section having a diameter larger than the diameter of the first hole section.

10. The fiber array of claim 9, wherein the geometry of the holes further comprises a third hole section for holding the lenses and controlling a position of a tip of each of the lenses with respect to a face of the substrate.

11. The fiber array of claim 1, wherein the glass fibers are rod lenses.

12. An optical device comprising:
a fiber array mated to a lens array, wherein the fiber array comprises a substrate made of a soft drillable material having a low coefficient of thermal expansion and a plurality of holes drilled through the substrate for holding a plurality of glass fibers; and
a lens array comprising a material exhibiting a coefficient of thermal expansion that substantially matches the coefficient of thermal expansion of the soft drillable material.

13. The optical device of claim 12, wherein the fiber array comprises a pyrolytic graphite material.

14. The optical device of claim 13, wherein the lens array comprises a fused silica material, and the coefficient of thermal expansion of the pyrolytic material and the fused silica material is less than 1.0×10⁻⁶/° C.

15. The optical device of claim 13, wherein the lens array comprises a glass/glass-ceramic composite plate, and the coefficient of thermal expansion of the pyrolytic graphite material and the glass/glass-ceramic composite is about 8.0×10⁻⁶ /° C.

16. The optical device of claim 12, wherein the soft drillable material is selected from the group consisting of machinable graphite and machinable ceramic.

17. A method of making a fiber array, comprising:
drilling a plurality of holes through a substrate made of a soft drillable material having a low coefficient of thermal expansion;
inserting glass fibers into the holes; and
securing the glass fibers in place in the holes.

18. The method of claim 17, wherein the soft drillable material comprises one selected from the group consisting of pyrolytic graphite, graphite, pyrolytic boron nitride, and boron nitride.

19. The method of claim 17, further comprising cutting ends of the glass fibers protruding from a face of the substrate using a laser.

20. The method of claim 17, wherein securing the glass fibers in place in the holes comprises filling the holes with a thermoset material and curing the thermoset material.

21. The method of claim 17, wherein the glass fibers are terminated with lenses.

22. A method of making a lensed fiber array, comprising:
drilling a plurality of holes through a substrate made of a soft drillable material having a low coefficient of thermal expansion;
inserting glass fibers into the holes;
securing the glass fibers in place in the holes; and
forming a lens on an end of each of the glass fibers protruding from a face of the substrate.

23. The method of claim 22, wherein the soft drillable material comprises one selected from the group consisting of pyrolytic graphite, graphite, pyrolytic boron nitride, and boron nitride.

24. The method of claim 23, wherein the soft drillable material has a coefficient of thermal expansion ranging from about 0.5 to 8.0×10⁻⁶/° C.

25. The method of claim 22, wherein securing the glass fibers in place in the holes comprises filling the holes with a thermoset material and curing the thermoset material.

26. The method of claim 22, wherein forming the lens comprises taper-cutting the end of each of the glass fibers protruding from the face of the substrate.

27. The method of claim 26, wherein forming the lens further comprises melting back the end of each of the glass fibers.
